(19) United States
(12) Patent Application Publication
(10) Pub. No.: US 2005/0235072 A1
(43) Pub. Date: Oct. 20, 2005

(54) Data storage controller

(76) Inventors: Wilfred A. Smith, San Jose, CA (US); Balakrishna D. Jayadev, San Jose, CA (US)

Correspondence Address: CHRISTIE, PARKER & HALE, LLP, PO BOX 7068, PASADENA, CA, 91109-7068, US

(21) Appl. No.: 10/953,056

(22) Filed: Sep. 29, 2004

Related U.S. Application Data
(60) Provisional application No. 60/563,204, filed on Apr. 17, 2004.
(60) Provisional application No. 60/601,345, filed on Aug. 13, 2004.

(51) Int. Cl. G06F 13/28

(52) U.S. Cl. 710/22

(57) ABSTRACT

Tags are associated with commands in a data storage system. Through the use of these tags, routing and processing of commands and data associated with the commands may be handled by software and/or one or more hardware ports. As a result data processing and routing may be automated and wide-ports may be supported without cross stack communication.

### CROSS-REFERENCE TO RELATED APPLICATION(S)

This application claims the benefit of U.S. Provisional Patent Application No. 60/563,204, filed Apr. 17, 2004, and U.S. Provisional Patent Application No. 60/601,345, filed Aug. 13, 2004 the disclosures of which are hereby incorporated by reference herein.

### TECHNICAL FIELD

This application relates to data processing and, more specifically, to a controller for storing data in data storage devices.

### BACKGROUND

In a conventional computing system, application programs (hereafter “applications”) may access data and/or data files stored in a data storage system. For example, a database application operates in conjunction with a database of information that may be stored in a data storage system. During the operation of the database application, various aspects of the application access data in the database.

A data storage system may include one or more data storage devices (hereafter referred to for convenience as “storage devices”). Storage devices store data magnetically, optically or by other means. Typically the devices are disk drive-based or solid state-based storage devices. Conventional types of data storage devices include serial advanced technology attachment (“SATA”), serial attached SCSI (“SAS”) and redundant array of independent disks (“RAID”).

A data storage system may include a data storage controller that handles requests from applications for data stored in one or more data storage components. In a typical implementation, the data storage controller receives data read and write requests from the application via messages generated by an operating system of the computing system. The data storage controller processes these requests to read data from or write data to one or more of the data storage devices.

In some computing systems, when an application requests data from the data storage system, the application does not need to “know” how or where the data is stored. In this case, the data storage controller may perform the necessary operations to keep track of where data is actually stored.

In practice, accesses to a data storage system may involve accesses to several storage devices. In conventional schemes, a data storage controller may support multiple storage devices by maintaining information for each device port in a separate information stack.

For relatively large data storage systems the process of transferring data to and from a large number of storage devices and keeping track of these data transfers may present numerous challenges. For example, it may be relatively difficult to scale the system or the efficiency with which data transfers are handled may be adversely affected. Accordingly, a need exists for improved techniques for managing and handling data transfers to and from a data storage system.

### SUMMARY

The invention relates to a system and method for controlling data transfers to and from a data storage system. For convenience, an embodiment of a system constructed or a method practiced according to the invention will be referred to herein simply as an “embodiment.”

In some embodiments a data processing system that includes one or more host computer(s) and/or server(s) (hereafter referred to as “the host” for convenience) may read data from and write data to one or more data storage systems (hereafter referred to as “the storage device” for convenience) using one or more controller(s) (hereafter referred to as “the controller” for convenience). For example, one or more application(s) executing on the host's operating system may need to store data in the storage device or retrieve data that was previously stored in the storage device.

In some embodiments the controller provides processing components for several ports, each of which connects to a different storage device or devices. The processing components for each port may include separate transmit and receive paths. For example, a transmit path may include a transmit manager, a transmit DMA engine and a transmit protocol stack. Similarly, a receive path may include a receive manager, a receive DMA engine and a receive protocol stack.

The host and controller use tags associated with a command to efficiently manage processing and routing of the data to and from the storage devices. For example, commands from the host may be processed by the transmit manager and sent to an appropriate storage device based on information in a tag associated with the command. The transmit DMA engine also may use the tag to transfer data to the storage device via the transmit protocol stack. Similarly, data received from a storage device may be processed by the receive protocol stack, then transferred by the receive DMA engine to the host using the tag.

The use of tags as described herein may provide several advantages over conventional data transfer techniques. For example, by enabling any of the ports to access the tag associated with a command, any of the ports may be used to process some or all of the data associated with a given command. Moreover, processing of the data may be efficiently passed between hardware and software components in the system through the use of these tags.

Accordingly, a data storage controller constructed in accordance with the teachings herein may provide advantages relating to, for example, storage context propagation in the system through tags to parallelize event processing; providing wide-ports with no cross-stack communication; tag aggregation for effective implementation of wide-port, expander and initiator/target functionality; automation for target mode through the use of DMA engines and hardware generated responses; automated fast-path (hardware) and slow-path (software) storage transaction caching and processing; isolation of transmit and receive paths for effective processing of system events in different functional modes; and a zero-read interface for providing status and other information to the host.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is a simplified block diagram of one embodiment of a data processing system including a data storage controller constructed according to the invention;

FIG. 2 is a simplified block diagram of one embodiment of components of a host and a data storage controller constructed according to the invention;

FIG. 3 is a simplified flowchart illustrating one embodiment of processing operations that may be performed by a host and data storage controller in accordance with the invention;

FIG. 4 is a simplified block diagram of one embodiment of a data storage controller constructed according to the invention;

FIG. 5 is a simplified block diagram of one embodiment of data flow during read operations according to the invention;

FIG. 6 is a simplified block diagram of one embodiment of data flow during write operations according to the invention;

FIG. 7 is a simplified block diagram of one embodiment of software (“SW”) and hardware (“HW”) processing and components according to the invention;

FIG. 8 is a simplified flowchart illustrating one embodiment of frame generation operations that may be performed in accordance with the invention;

FIG. 9 is a simplified flowchart illustrating one embodiment of frame processing operations that may be performed in accordance with the invention;

FIG. 10 is a simplified flowchart illustrating one embodiment of initiator read operations that may be performed in accordance with the invention;

FIG. 11 is a simplified flowchart illustrating one embodiment of initiator write operations that may be performed in accordance with the invention;

FIG. 12 is a simplified block diagram of one embodiment of a data processing system including a data storage controller constructed according to the invention;

FIG. 13 is a simplified flowchart illustrating one embodiment of target read operations that may be performed in accordance with the invention;

FIG. 14 is a simplified flowchart illustrating one embodiment of target write operations that may be performed in accordance with the invention; and

FIG. 15 is a simplified block diagram of one embodiment of a data processing system including a data storage controller constructed according to the invention;

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus or method. Finally, like reference numerals denote like features throughout the specification and figures.

### DETAILED DESCRIPTION

The invention is described below, with reference to detailed illustrative embodiments. It will be apparent that the invention may be embodied in a wide variety of forms, some of which may be quite different from those of the disclosed embodiments. Consequently, the specific structural and functional details disclosed herein are merely representative and do not limit the scope of the invention.

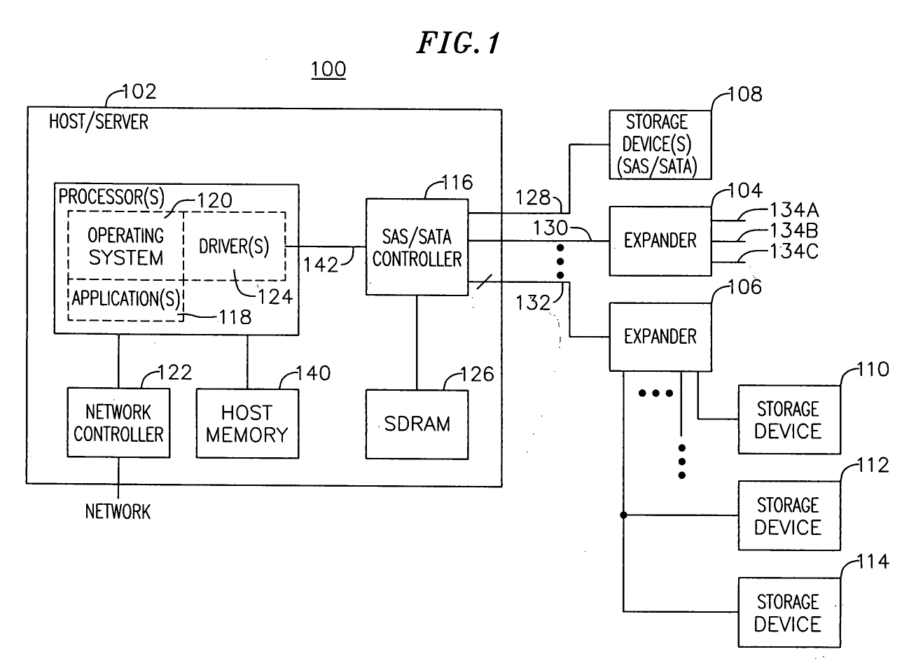

FIG. 1 illustrates one embodiment of a computing system 100 incorporating a controller for controlling a variety of storage devices. The computing system 100 includes a host computer or server (hereafter referred to as “the host” for convenience) 102. The host 102 is configured to write data to and read data from one or more data storage systems. The data storage systems may include expanders 104 and 106 and various storage devices 108, 110, 112 and 114 (hereafter referred to collectively as “the storage devices” or individually as “a storage device” for convenience).

The host 102 includes or may be connected to one or more controller(s) (hereafter referred to as “the controller” for convenience) 116 that facilitates storage and retrieval of data to/from the storage devices. FIG. 1 illustrates an embodiment where the controller 116 is located in the host 102 and communicates with other components in the host 102 via a host bus 142. It should be appreciated, however, that the teachings herein are applicable to other configurations and architectures.

One or more application(s) 118 executing on the host's operating system 120 may need to store data in a storage device or retrieve data that was previously stored in a storage device. Alternatively, an application executing on a processor external to the host may access a storage device via a data network (e.g., the Internet) that connects to the host via a network controller (e.g., a Gigabit Ethernet controller) 122 or via the controller 116.

Conventionally, the operating system 120 communicates with the controller 116 via a set of drivers 124. Along with this configuration, a set of commands, responses and other messages are defined to facilitate the transfer of data to and from the data storage devices. For convenience, communications between the controller 116 and the drivers 124, operating system 120 and applications 118 may be referred to herein as communications between the controller 116 and the host 102.

The components depicted in FIG. 1 typically include some form of data memory such as RAM and ROM. For example, the host 102 includes host memory 140 that may be accessed by, for example, the applications 118, the operating system 120, the drivers 124 and the controller 116. In addition, the controller 116 may have a dedicated memory such as an external SDRAM 126.

The controller 116 connects to the storage devices via several ports. Three port lines 128, 130 and 132 are labeled in FIG. 1. As represented by the ellipses, however, a controller may have many more ports.

The controller 116 may be configured to support one or more data storage standards supported by the various storage devices. For example, when the controller is an SAS/SATA controller as depicted in FIG. 1, the controller may control SAS storage devices and/or SATA storage devices (e.g., storage device(s) 108).

In some applications, each port (e.g., port 128) may connect to one or more storage devices. For example, storage device 108 may represent one or more storage devices.

In some applications a port (e.g., port 130) may connect to an expander (e.g., expander 104) that enables the port to connect to several storage devices via several expansion ports provided by the expander. Three expansion ports 134A, 134B and 134C are labeled in FIG. 1. In practice, however, an expander will typically have many more expansion ports.

In some applications (called “wide-ports”), several controller ports (e.g., ports 132) may be connected to an expander (e.g., expander 106). The expander 106 may then connect any of these ports 132 to any of several storage devices (e.g., storage devices 110, 112 and 114) via the expander's expansion ports (e.g., expansion ports 136 and 138).

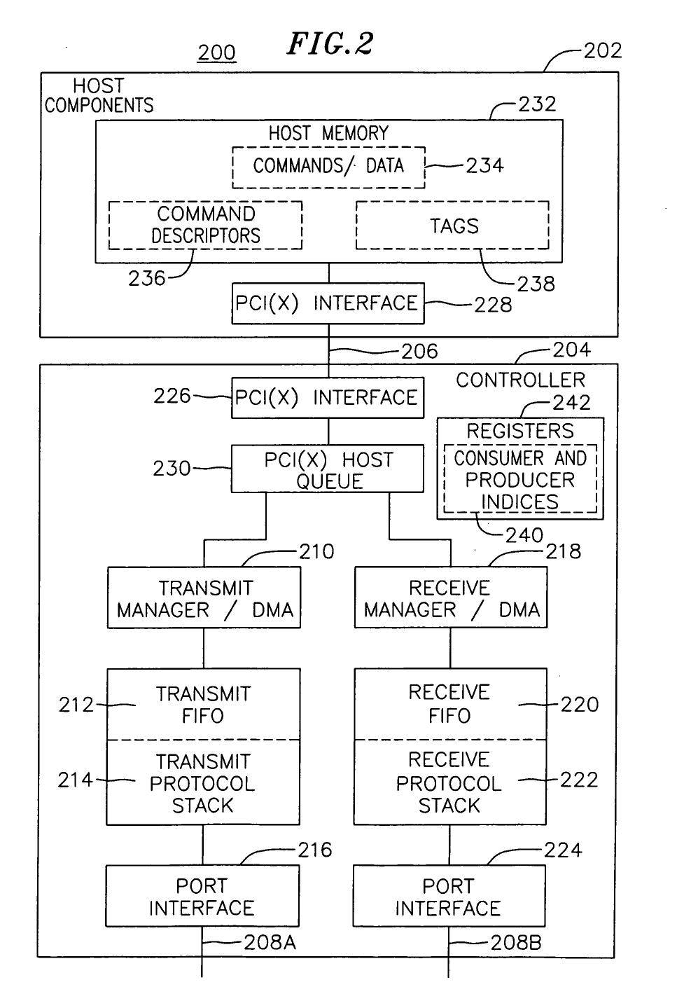

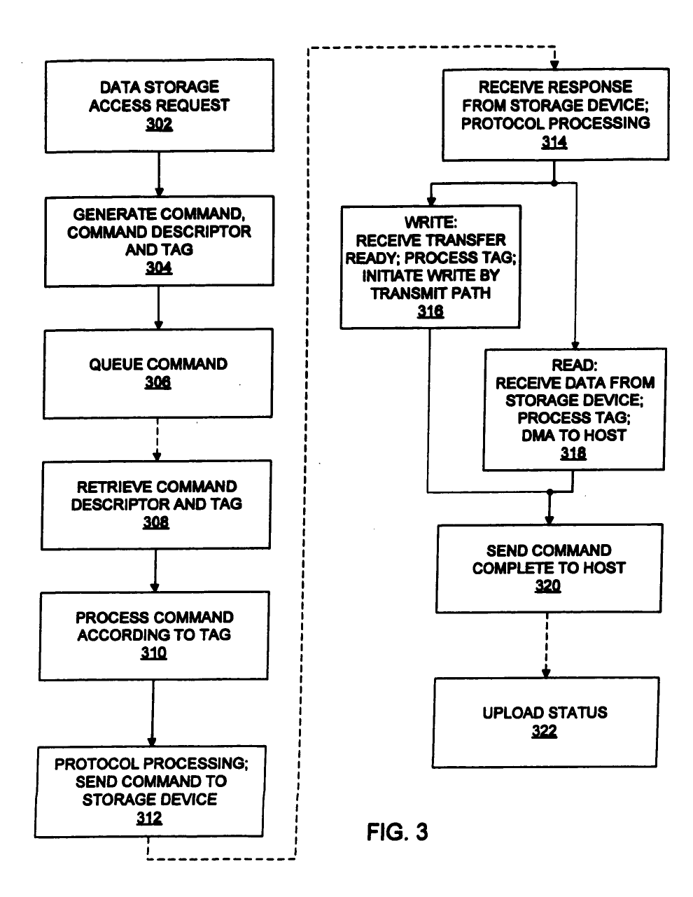

Examples of operations of the host 102 and the controller 116 will be discussed in more detail in conjunction with FIGS. 2 and 3. FIG. 2 is a simplified block diagram 200 of one embodiment of several components of a computer such as a host computer (hereafter referred to for convenience as “host 202”) and a controller 204. FIG. 3 is a flowchart that illustrates various operations that may be performed by the host 202 and the controller 204 to transfer data between the host 202 and, for example, several storage devices (not shown in FIG. 2).

Briefly, the operation of the controller 204 may involve processing requests from the host 202 to send data to or retrieve data from the storage devices. To this end the controller 204 supports one or more connections to the host (e.g., bus 206) and one or more connections to storage devices (e.g., transmit/receive port 208A-B). In addition, the controller 204 may include transmit path components (e.g., components 210, 212, 214 and 216) and receive path components (e.g., components 218, 220, 222 and 224) that format and unformat data that is sent to or received from, respectively, a port. For convenience, FIG. 2 only illustrates components associated with one port in the controller 204.

In some embodiments, the controller 204 interfaces with the host 202 via a PCI bus 206. In these embodiments the controller 204 and the host 202 include a PCI(X) interface 226 and 230, respectively, that handles data transfers to and from the PCI bus 206. The PCI(X) interfaces may support one or more of the PCI, PCI-X and PCI Express standards.

In some embodiments, the controller includes a queue (designated PCI(X) HOST QUEUE) 230 where data received from the PCI bus 206 and data to be sent to the PCI bus 206 may be temporarily stored. In this case, the transmit path components may retrieve data from the queue 230 and the receive path components may load data into the queue 230.

In general, the transmit path components process data (e.g., commands and, for write operations, write data) received from the host via the PCI bus and send the processed data to an appropriate storage device or devices. The embodiment of FIG. 2 includes a transmit manager and direct memory access (“DMA”) engine 210 that facilitates automated and efficient transfer of the data. The transmit manager/DMA engine 210 may include for example, processing for handling commands, establishing connections and performing DMA transfers. The controller 204 also may include a transmit FIFO (first-in first-out memory) for placing data to be processed by a transmit protocol stack 214.

The transmit protocol stack 214 handles routing of the data to be sent out the transmit port 208A according to the requirements of the storage device(s). For example the protocol stack 214 may provide transport, port, link and physical protocol layer functionality to communicate with a SAS storage device or a SATA storage device.

The controller also may include port interface components 216 and 224. For example, the port interface components may provide serializer/deserializer (“SERDES”) functionality to interface with serial connections to the storage devices.

In a complementary manner, the receive path components process data (e.g., responses and, for read operations, received data) received from the data storage devices via the receive port 208B. Thus, the controller 200 may include a receive protocol stack 222 that provides transport, port, link and physical protocol layer functionality to receive data from a SAS storage device or a SATA storage device. The received data may be temporarily stored in a receive FIFO 220. A receive manager/DMA engine 218 facilitates automated and efficient transfer of the received data to the host 202 via the PCI bus 206.

An example of the operation of these components will be treated in more detail in conjunction with the flowchart of FIG. 3. Blocks 302-306 relate, in general, to operations performed by software (e.g., application, operating system and/or driver software) executing on, for example, the host 202.

As represented by block 302 the host 202 (or some other initiator processing system) initiates requests to access data stored in a storage device controlled by the controller 204. As an example, these requests may derive from application programs that need to retrieve or save a document stored in a database. To this end the application sends a request such as a read or a write to the operating system. The operating system determines where the request will be sent (e.g., which storage device) and assembles all the information that is needed by the driver to send the request to the controller. In general, the driver is designed to provide requests to the controller in the specific format required by the controller.

As represented by block 304, the driver generates a command (e.g., a read or write) and any associated data (e.g., for a write) 234 and stores the command/data 234 in host memory 232. The driver also generates a command descriptor 236 and tag 238 that are associated with each command. The command descriptor 236 and tag 238 contain information used by the controller 204 to process and route the command. In addition, the command descriptor 236 includes a reference to the associated tag 238.

As represented by block 306, the driver queues each of the commands in the host memory 232. The controller 204 then processes the host commands by retrieving the commands from the host memory 232. This command queuing technique enables the controller 204 to decouple the host command sequence from the channel execution. That is, the controller 204 may finish processing one command before it selects another command for processing.

In some embodiments the host 202 and the controller 204 use a shared command descriptor ring to communicate information related to each command. The ring may be composed of an array of command descriptors 236 that reside in the host memory 232.

The DMA operations also may be executed using a command ring structure. Data for command operation may be provided using the command descriptors 236. For example, each command descriptor 236 may contain command related information, address pointers to data buffers and a variety of control information.

In some embodiments a producer index and a consumer index 240 are used to control which descriptors are valid for a given ring. When incremented, the producer index may be used to add elements to the ring. Conversely, when incremented the consumer index may be used to remove elements from the ring. The difference between the producer and consumer indices indicates which descriptors are currently valid in the ring. When the producer and consumer index are equal, the ring is empty. As illustrated in FIG. 2, the host 202 may store the consumer and producer indices 240 in registers 242 in the controller 204. This may be accomplished, for example, using memory mapped I/O.

Typically, each port (e.g., port 208A-B) in the controller 204 may have a separate ring structure to communicate with the host 202. Thus, a controller 204 with eight ports may communicate with the host 202 via eight ring structures.

As represented by the dashed line between blocks 306 and 308, the blocks 308-312 relate, in general, to different processing activity, namely, processing in the transmit path of the controller 204. The controller 204 continually monitors the consumer and producer indices 240 to determine whether a command to be processed is in the queue. For example, the controller may continually poll the registers 242 to determine whether the producer index and consumer index for a given port are not equal. Alternatively, an interrupt mechanism may be used.

Some embodiments use a single interrupt line for all of the controller port control blocks. For example, a Global Interrupt Status register may provide the status of interrupts from each of the ports. In addition, a QDMA Status Register (QSR) may identify the Interrupt Source for a port. The controller 204 may then incorporate an interrupt coalescing mechanism to pace the interrupts generated to the host 202.

As represented by block 308, after the controller 204 determines that a command is queued for processing, the transmit manager/DMA engine 210 retrieves the associated command descriptor 236 and the associated tag 238 from the host memory 232. In some embodiments the tag may indicate where the associated command and data are stored in the host memory 232. For example, the tag may contain an address in a scatter gather list (“SGL”) associated with the write command.

Thus, using information in the command descriptor 236 and the tag 238 the transmit manager/DMA engine 210 causes the command and data to be transferred over the PCI bus 206 to the queue 230. In some embodiments the queue 230 is used as a temporary storage where the data transferred between the controller 204 and the PCI bus 206 may be stored in the format of the PCI bus protocol. The transmit manager/DMA engine 210 then processes the command as necessary, ensures a connection is established to the appropriate storage device(s) and causes the command to be transferred to the transmit FIFO 212 (block 310).

As represented by block 312, the transmit protocol stack 214 provides protocol processing for the command in the transmit FIFO 212 according to the protocol specified in the tag 238. For example, the protocol processing may provide appropriate processing to send the command to a SAS device or a SATA device. The command is sent to the storage device(s) via the port interface 216 and port 208A.

As represented by the dashed line between blocks 312 and 314, blocks 314-320 relate, in general, to different processing activity, namely, processing in the receive path of the controller 204. At block 314, as a result of the transmitted command the controller receives a response from the storage device(s) via the port 208B and the port interface 224. The response received using the receive protocol stack 222 is placed into the receive FIFO 220.

As represented by block 316, if the command was a write command, the response should eventually include an indication that the storage device(s) is ready to receive the write data and associated tag information. In this case, the receive manager/DMA engine 218 processes the received tag and provides this information to the transmit path. This causes the transmit manager/DMA engine 210 to load the write data into the transmit FIFO 212. The tag information is used to determine the appropriate protocol processing and to send the formatted write data the appropriate storage device(s).

Alternatively, as represented by block 318, if the command was a read command, the response will include the requested data and associated tag information. In this case, the receive manager/DMA engine 218 uses the received tag to transfer the data to the appropriate location in host memory 232 via the PCI bus 206. For example, the tag may indicate an address in a scatter gather list (“SGL”) associated with the read command.

In either case, the controller 204 will send a command complete indication to the host 202 (block 320). Again the tag information may be used to store this indication in an appropriate location (e.g., at the end of the SGL) in the host memory 232.

As represent by block 322, the controller 204 also may occasionally upload status information to the host 202. In some embodiments, the controller 204 provides a zero read interface that may be used to eliminate some of the delays that would otherwise be incurred by the host 202 in performing read operations over the PCI bus. For example, the controller 204 may periodically perform a DMA operation to write a status update block to host memory 232. Thus, when the host 202 needs to access the status information, it may simply access the information that is already in its memory 232, thereby eliminating the need for the host to access the PCI bus to obtain status. In some embodiments, all of the information the host 202 needs to process all accesses to and from the storage device(s) may be stored in the status update block. This information may include, for example, consumer and producer indices, error messages, interrupt status register content and S active bits for SATA and SAS SRBs.

This mechanism provides further advantage via the operation of the host's cache. As an example, when the host 202 needs to determine whether a command has completed, it may read the status information from memory 232. This operation typically will cause the data to be written to the host's cache. Subsequent reads of this information may then be from the cache (until the data in memory is rewritten).

Thus, this mechanism may reduce PIO reads in the system by DMAing the status into the host memory periodically. One example of this mechanism follows.

A QDMA status timing register (QSTR) will be written by the driver to set the frequency of status block updates in host memory. Setting a Status Update Enable bit in a global control register enables the automatic status update. The status timeout counter is in a reset state until a status change occurs in any of the active ports. At this time a status block is DMAed into the address pointed by the QDMA Status Address Register. The QSTR value is loaded into a status timeout counter and counted down. When the timer expires, if there is any change in status a status block is DMAed into the host memory and the status timeout counter is loaded again with the value in QSTR and the process repeats. When the status timeout counter expires, if there is no status change then there is no update to the memory and the counter will be in a reset state. The entire process repeats again when there is a new change in status of any active ports.

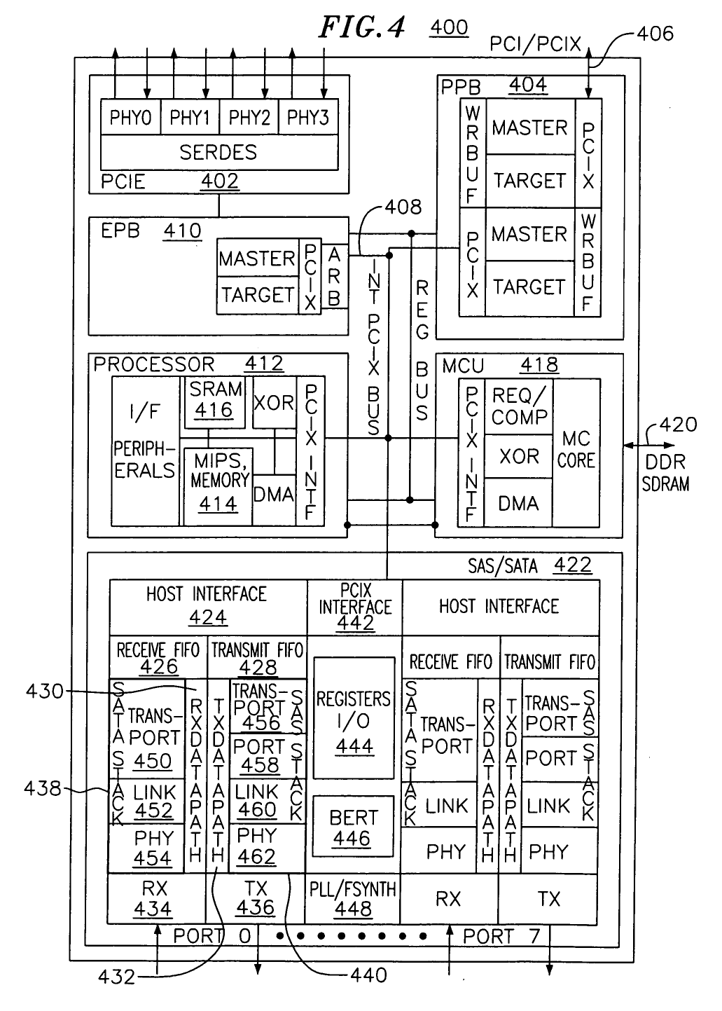

FIG. 4 depicts a simplified block diagram of one embodiment of a single chip SAS-SATA controller 400. In this embodiment the controller 400 supports eight SATA or SAS ports. It should be appreciated, however, that the concepts described herein may be applicable to other standards and architectures.

The SAS-SATA controller 400 includes interfaces to several PCI buses. A PCI-Express interface (“PCIE”) 402 includes, for example, four physical interfaces (PHYO-4) and a serializer-deserializer (“SERDES”) block. A PCI-X interface (“PPB) 404 includes, for example, an interface to the host's PCI/PCI-X bus 406 and an interface to an internal PCIX bus 408. The controller 400 also includes a PCI-Express to PCI-X bridge (“EPB) 410 that includes an interface to and arbitration block (“ARB”) for the internal PCIX bus 408.

The controller 400 includes a processor component 412 such a MIPS processor and associated cache memory 414, external memory 416 and I/O (not shown) . The controller 400 also may include a memory controller unit (“MCU”) 418 that may provide access to, for example, an external DDR SDRAM (not shown) via a bus 420. The processor 412 and the MCU 418 each include a PCI(X) interface and a DMA component.

A SAS/SATA block 422 provides processing for eight SAS or SATA ports (port0-port7). To simplify the diagram ports 1-6 are not shown but are instead represented by the ellipses. Associated with each port are several processing components including a host interface 424, a receive FIFO 426, a transmit FIFO 428, a receive data path (represented by the block 430), a transmit data path (represented by the block 432), a port receive (“RX”) block 434, a port transmit (“TX”) block 436, a SATA stack 438 and a SAS stack 440.

The host interface 424 may include, for example, the components 210 and 230 from FIG. 2. In general, the host interface 424 manages all data transfers from host memory (via the PCIX interface 442) to and from the transmit and receive FIFOs 426 and 428 and manages the protocol stacks 438 and 440.

Each SATA stack 438 provides transport 450, link 452 and physical (“PHY”) 454 layer processing. Each SAS stack 440 provides transport 456, port 458, link 460 and physical (“PHY”) 462 layer processing. Each of the port blocks may be referred to herein as a port controller. To reduce the complexity of FIG. 4 only the components for port 0 are labeled.

The SAS/SATA block 422 also includes non-port specific functionality including a PCIX interface 442 to the internal PCIX bus 408, various registers and peripheral I/O (e.g., GPIO and MDIO) and interfaces to various buses (e.g., I²C and SEMB) 444, a bit error rate test block (“BERT”) 446 and a phase lock loop and frequency synthesizer (“PLL/FSYNTH”) 448.

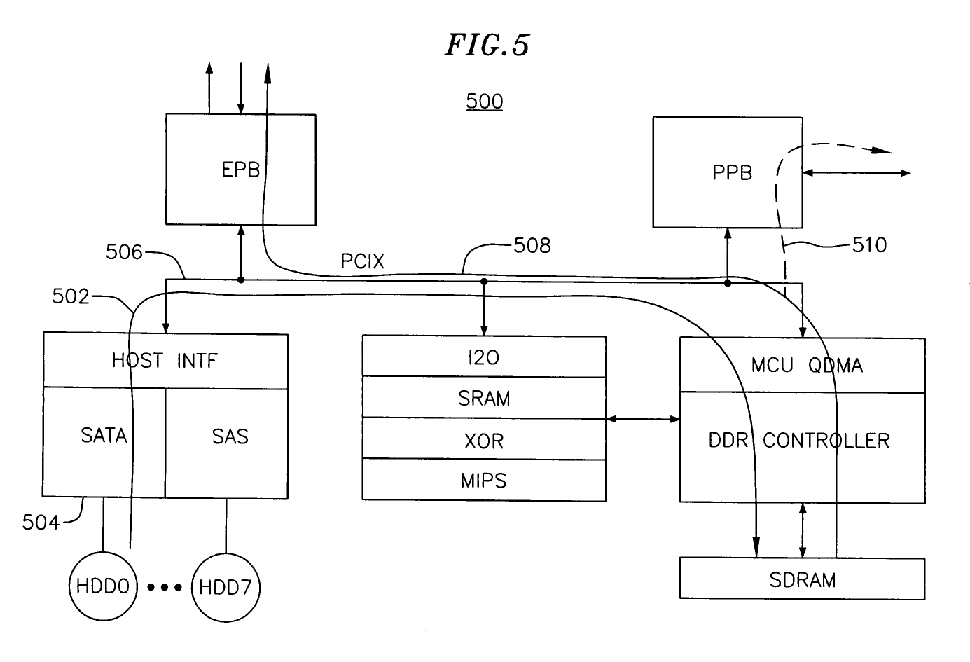

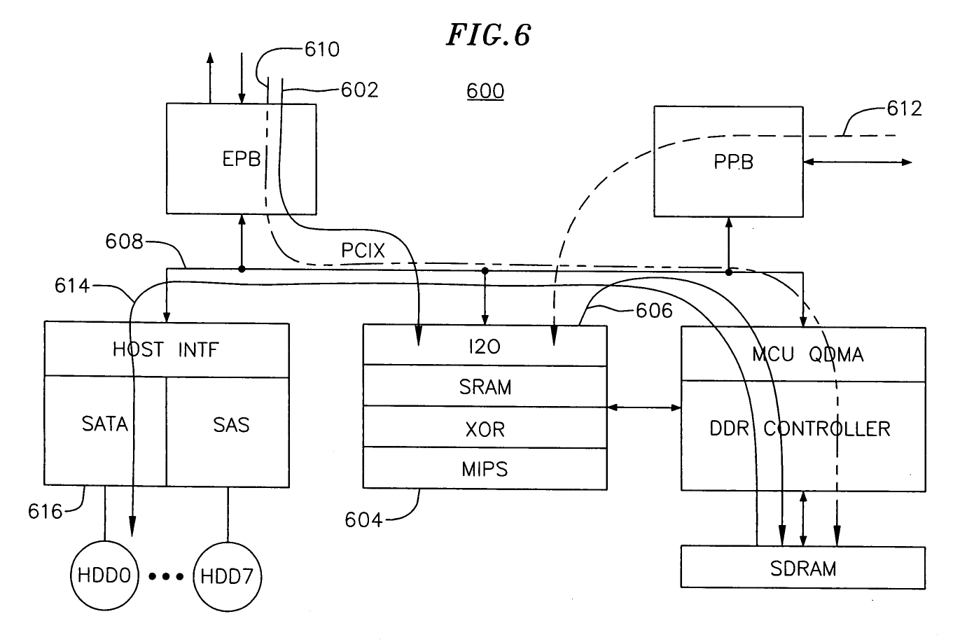

Examples of data transfers in one embodiment of a SAS/SATA controller will be described in more detail in conjunction with FIGS. 5 and 6. FIG. 5 relates to data read operations in a controller 500. FIG. 6 relates to data write operations in a controller 600.

In FIG. 5, as represented by line 502, data is read from a SATA hard disk drive (e.g., HDDO) through a port controller 504 providing (in this example) SATA protocol processing. A queue DMA controller in the MCU (“MCU QDMA”) transfers the data from the port controller 504 over the internal PCIX bus 506 to a DDR controller which then stores the data in SDRAM.

As represented by solid line 508, the MCU QDMA may transfer data from the SDRAM over the internal PCIX bus 506 to a PCI-Express bus via a PCI-Express to PCI-X bridge (“EPB”). Alternatively, as represented by dashed line 520, the MCU QDMA may transfer data from the SDRAM over the internal PCIX bus 506 to a PCI-X bus via a PCI to PCI bridge (“PPB”).

Referring now to FIG. 6, as represented by solid line 602 a write command received from the PCI-Express bus may be sent from the PCI-X bridge (“EPB”) to the MIPS processor 604 via an internal PCIX bus 608. The MIPS processor 604 may then write the data to the SDRAM via the DDR controller (line 606) via the PCIX bus 608.

Alternatively, as represented by dashed line 612, a write command received from the PCI-X bus may be sent from the PCI to PCI bridge (“PPB”) to the MIPS processor 604 via the PCIX bus 608. The MIPS processor may then write the data to the SDRAM via the DDR controller (line 606).

Alternatively, as represented by dash-dot line 610, the host software may write directly into the SDRAM. For example, the MCU QDMA may transfer the data over the internal PCIX bus 608 to the SDRAM via the DDR controller.

As represented by line 614, data from the SDRAM may be transferred in a DMA operation to a hard disk drive 616 to complete the write operation.

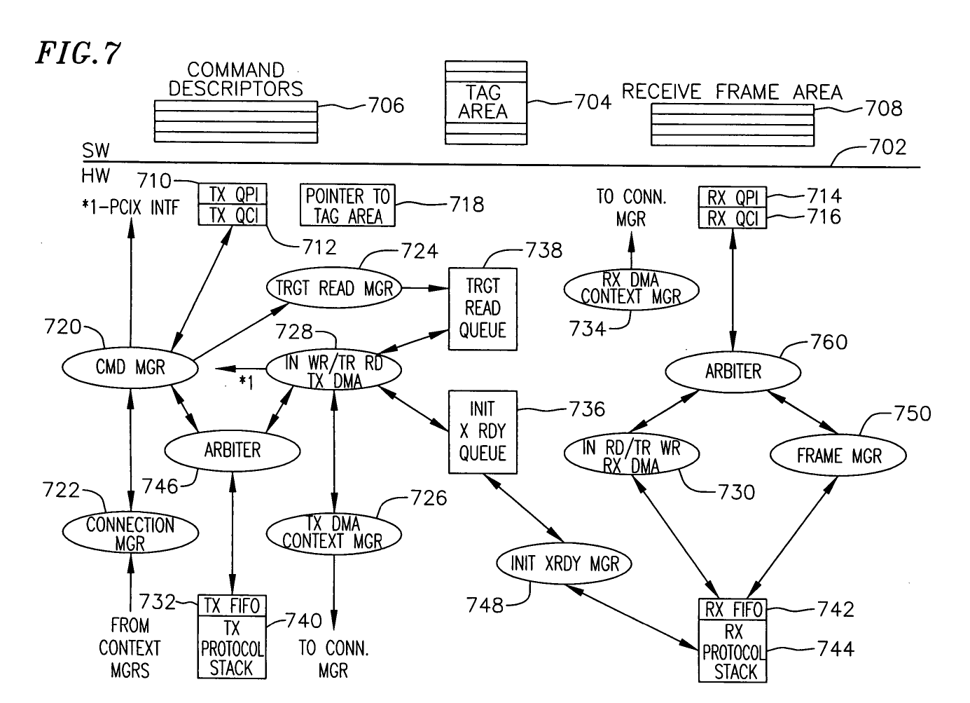

Referring now to FIG. 7, various structures and operations of the hardware and software in one embodiment of a SAS-SATA controller that utilizes a data structure sharing technique such as discussed above will now be discussed in more detail. The blocks above line 702 relate, in general, to software (“SW”) operations that may be performed, for example, by the driver software. The blocks below the line 702 relate, in general, to hardware (“HW”) operations that may be performed, for example, by the controller hardware. In general, the hardware transmit data path and the hardware receive data path components are depicted on the left side and the right side of FIG. 7, respectively. In general, the illustrated hardware components relate to the components 210, 212, 214, 218, 220, 222, 230 and 242 from FIG. 2 except for queue components 736 and 738. Again, to reduce the complexity of FIG. 7, only the components for one port are illustrated.

In accordance with the data structure sharing technique, a tag area 704 stores tags associated with each read operation and each write operation handled by the controller. Each tag includes a table of information that is used to track the read or write operation.

Through the use of such tags, the controller may efficiently control multiple data transfers associated with a single port or control a single data transfer associated with multiple ports. For example, in the latter case, data associated with a given data transfer may initially be sent out port 1, then received on port 2, then sent out port 4, then received on port 3. The tag scheme described herein provides an efficient manner of accomplishing complex data transfers such as these.

Moreover, through the use of these tags the controller can support wide-ports without providing some of the data management capabilities that are specifically designed for wide-ports. Conventional wide-port systems integrate all the information for all wide-ports data transfers into a master object. In contrast, the controller described herein may maintain information (e.g., context information) associated with each data transfer in the tags. As a result, processing for the data transfers may be “handed off” to another port. For example, as the data comes into another port, the port controller may look up the tag (to access the context information in the tag) to determine how the data is to be processed. Thus, it may not be necessary to pool all information associated with wide-port data transfers. As a result, there may be no need for a master object across all ports as may be required in conventional wide-port system.

Referring to FIG. 7, the tag area 704, command descriptors 706 and a receive frame area 708 are stored in a memory such as host memory. Associated with each tag is a tag context that contains information related to the command. The tag context information associated with each tag is stored in the tag area 704. The receive frame area 708 is used to hold various data that is sent from the hardware to the software.

The consumer and producer indices are stored in registers in the hardware. These indices include a transmit queue producer index 710, a transmit queue consumer index 712, a receive queue producer index 714 and a receive queue consumer index 716.

A pointer 718 to the tag area 704 is also stored in the registers. The hardware may use this pointer to access the tag context information.

A command manager 720 performs operations including, for example: monitoring the transmit queue producer index 710 for a valid command; interfacing with a connection manager 722 for establishing connections; maintaining a scratch pad area for command descriptor (“CD”) processing; generating command and data frames; interfacing with a target read manager 724 for target read data frames; communicating with a transmit context manager 726 for context maintenance; and generating command descriptor and information unit fetch requests towards the PCIX interface (“PCIX Intf”).

The connection manager 722 performs operations including, for example: receiving requests from the command manager 720, a transmit DMA engine 728 and a receive DMA engine 730; maintaining a cache of recent connection information; generating requests towards the command manager 720 and the DMA engines 728 and 730 for a command descriptor fetch based on a cache hit; and establishing connections based on an arbitration scheme performed by a transmit arbiter 746 where the winner is allowed to load its frames into the transport buffer (e.g., by loading the frames into the transmit FIFO 732).

The transmit DMA engine 728 performs operations including, for example: fetching data for initiator writes and target reads from the host memory; generating these fetches based on the context of the TAG in process; controlling a transfer ready (“XRdy”) queue 736 and updating a target read queue 738. In addition, requests from the connection manager 722 and the context manager 720 for the TAG context (“TC”) fetch are routed to the PCIX interface through the transmit DMA engine 728.

Context managers (Transmit DMA Context Manager 726 and receive DMA context manager 734) performs operations including, for example, maintaining tag contexts for the associated DMA engine 728 or 730. The contexts are stored based on command descriptors processed by the command manager. 720 and the current state of the associated DMA engine 728 or 730. A context in the cache is updated if it is in a modified state and being evicted.

As discussed above in conjunction with FIG. 2, the controller includes a transmit FIFO 732, a transmit protocol stack 740, receive FIFO 742 and a receive protocol stack 744. The other components in FIG. 7 are discussed below.

As discussed above, the software associates a command descriptor and a tag context with each command. Examples of a command descriptor and a tag context are described in Table 1 and Table 2, respectively.

TABLE 1

| | |
|---|---|
| TAG | 2 bytes |
| Connection TAG | 2 bytes |
| Length in Dwords | 1 byte |
| Flags | 3 bytes |
| IU Pointer | 8 bytes |
| Total length | 16 bytes |

In Table 1 the tag field identifies the tag associated with this command descriptor (and hence the associated command). In this example, the controller support up to 64K different tags. Thus, each tag is assigned a unique number from zero to 64K.

The connection tag field identifies a tag associated with a connection to a storage device. For example, a physical path is established between every initiator and target. Each unique physical path (e.g., a unique source address and destination address pair) is associated with a unique connection. By associating a connection tag with each opened connection (and the associated addresses), the controller may simply check the connection tags to determine whether a particular connection has already been established. This will enable the controller to more efficiently transfer data to and from the storage devices.

In this example, the controller support up to 64K different tags. Thus, each tag is assigned a unique number from zero to 64K.

Typically the connection tags are initialized when the system is booted and when resources (e.g., storage devices) are added to or removed from the system. As the operating system opens and closes connections the operating system updates the connection tags.

Referring again to Table 1, the length field indicates the length of the command stored, for example, in the host memory. The flags field may be used for various operations. The information unit (“IU”) pointer field may be, for example, an address in host memory where the information unit for the associated command is stored. The information unit may include, for example, the command and data. The total length field indicates the length of the command descriptor.

TABLE 2

| | |
|---|---|
| Protocol | 3 bits |
| Initiator | 1 bit |
| Connection Rate | 2 bits |
| Connection TAG | 16 bits |
| Destination/Source | 64 bits |
| SAS Address | |
| Target/Initiator TAG | 16 bits |
| Flags | 24 bits |
| SGL Information | 16 + 16 bytes |
| | (Bidirectional |
| | command) |
| Total length | 48 bytes |

Referring now to Table 2, the protocol field may indicate the protocol supported by the storage device, for example, SATA or SAS. The initiator field indicates whether the controller is an initiator or a target for the associated command. The connection rate field may identify the speed of the connection.

The connection tag field identifies the connection tag associated with the command. In this example, the controller support up to 64K different tags. Thus, each tag is assigned a unique number from zero to 64K.

The destination/source address field contains the address of the storage device. In this example, the storage device is a SAS device.

The target/initiator tag field identifies the tag associated with the command. As discussed above, this tag may be associated with either target or initiator mode of operation. In this example, the controller support up to 64K different tags. Thus, each tag is assigned a unique number from zero to 64K.

The flags field may be used for various operations. The SGL information field may be, for example, a location in the SGL (e.g., in host memory) for the associated command. The total length indicates the length of the tax context.

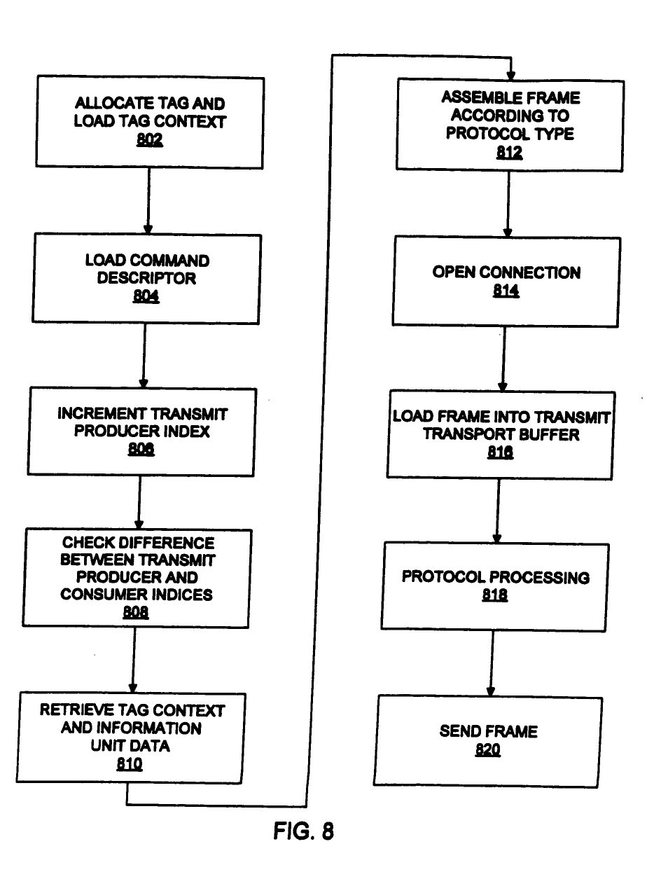

Various operations of the components illustrated in FIG. 7 will be discussed in more detail in conjunction with FIGS. 8-14. Commands and data are sent to and received from a storage device in a frame format as defined by, for example, the SAS protocol. Accordingly, both read and write operations involve generating one or more frames to send the read command or the write command and associated data to the storage device. FIG. 8 describes several of these frame generation operations.

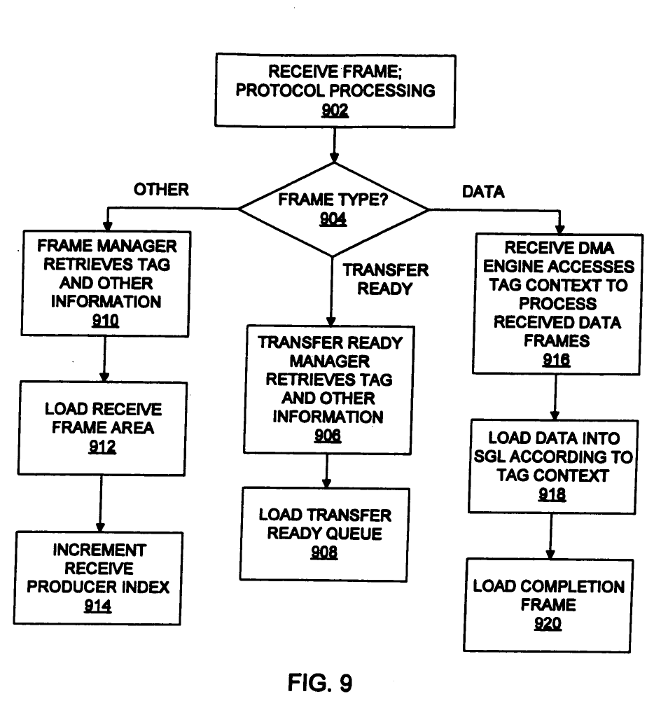

In addition, both read and write operations involve processing one or more frames received from the data storage device. For example, the storage device may send a transfer ready indication upon receipt of a write command. In addition, the storage device may send the requested data in response to a read command. Also, the storage device may send a command complete indication once it has completed processing a command. FIG. 9 describes several of these frame processing operations.

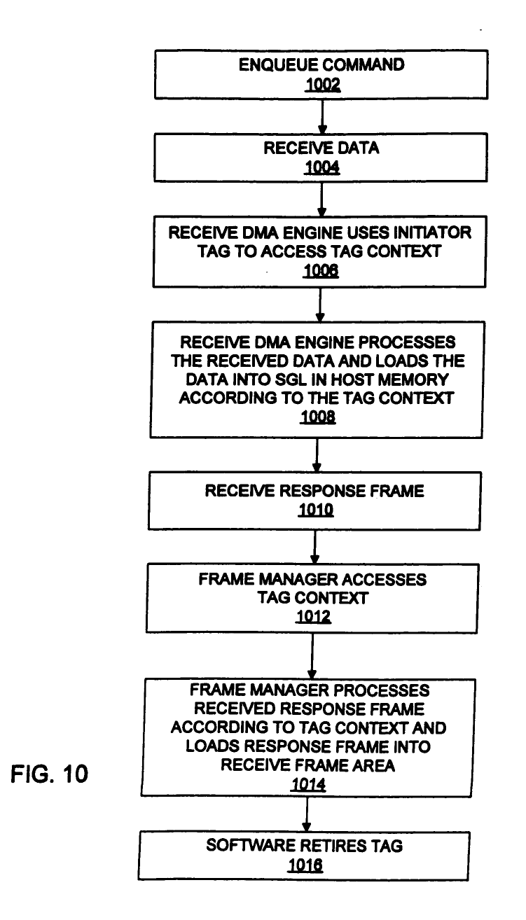

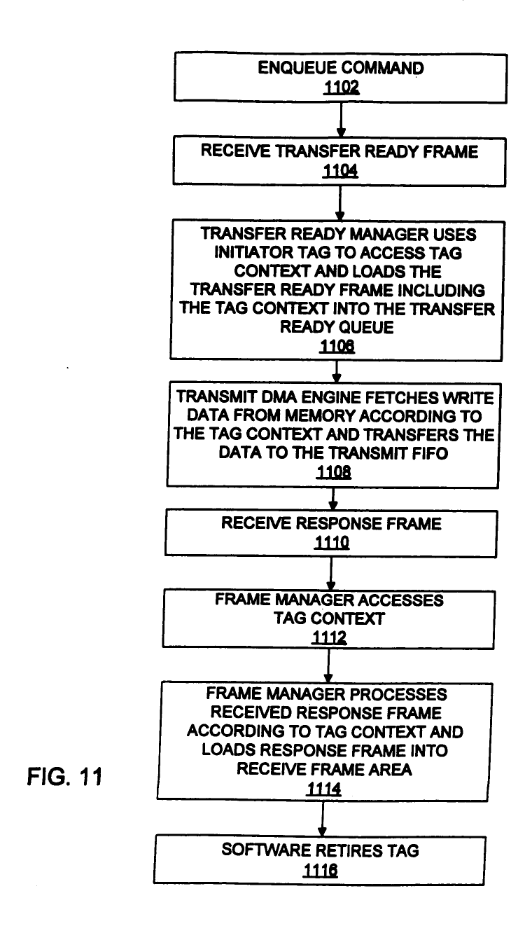

The controller may operate as a target and/or as an initiator. For example, when the host sends a command to the controller the controller is the initiator to the target storage device. FIGS. 10 and 11 describe several operations associated with a read command and a write commend, respectively, when the controller is an initiator.

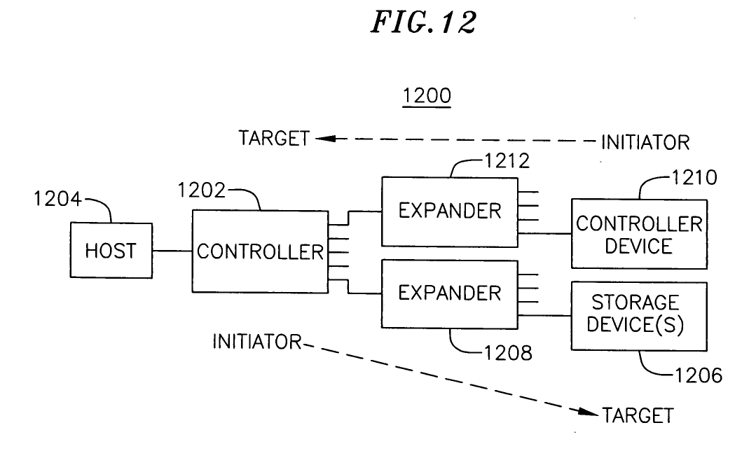

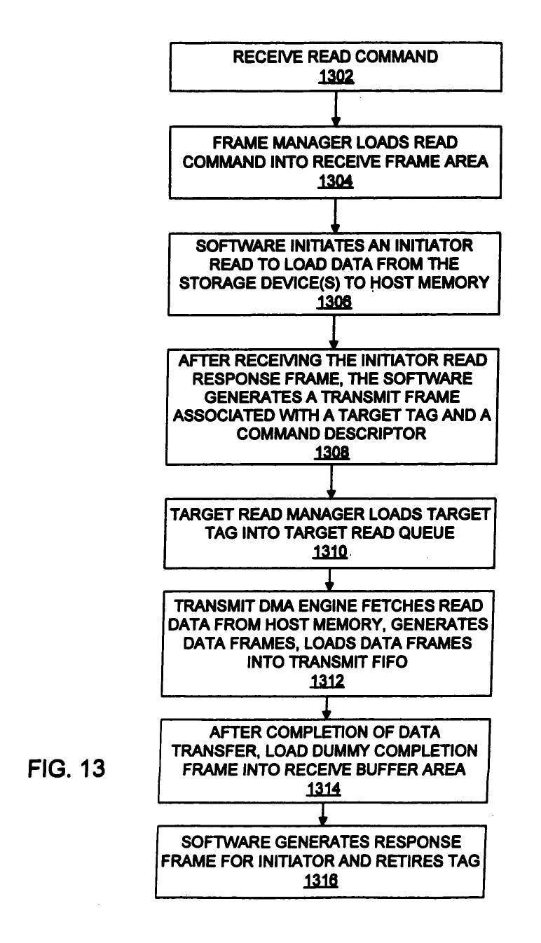

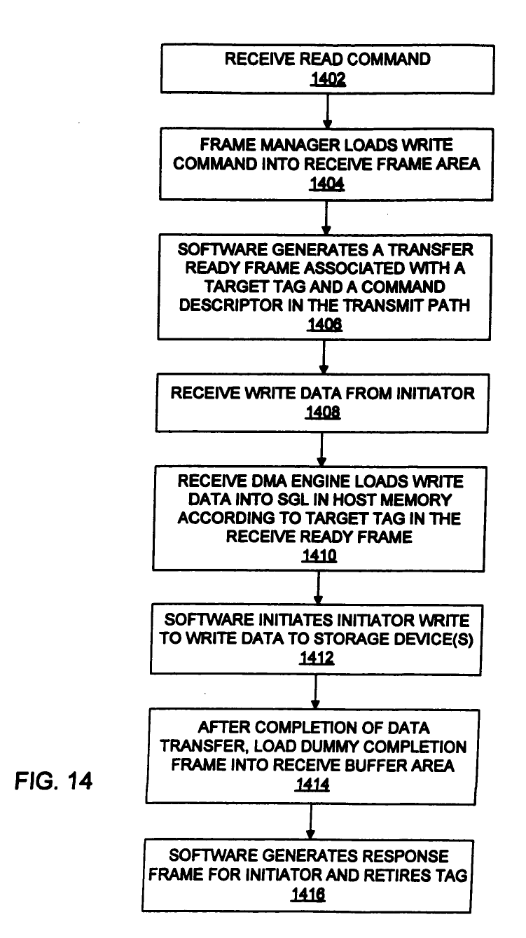

Alternatively, as illustrated in FIG. 12 a device connected to one of the controller's ports may send a command to the controller requesting to read data from or write data to a storage device controlled by the controller. When the command is received from a device (e.g., another controller or a storage device) the controller is the target for that initiator. The controller then performs initiator operations to the ultimate target storage device to read from or write to the target storage device. Hence, to processes this command, the controller operates as both a target and an initiator. FIGS. 13 and 14 describe several operations associated with a read command and a write commend, respectively, when the controller is a target.

Referring to FIG. 8, a request to access data stored in a storage device controlled by the controller causes a frame (including, for example, a read or write command and, for a write operation, write data) to be loaded into the command queue as discussed above. As represented by block 802, the software allocates a unique tag for the command frame and loads the tag context into the tag area 704.

At block 804, the software generates a command descriptor and loads it into the command descriptor buffer 706. As discussed above, the command descriptor may include the allocated tag, the connection tag, the length of the command unit and the flags.

As represented by block 806, the software increments the transmit queue producer index 710. In this way the producer index 710 may be set to a value greater than the consumer index 712 to indicate that a command descriptor is ready to be processed.

As discussed above, the hardware continually checks the values of the transmit queue producer index 710 and the transmit queue consumer index 712 (block 808). When a command descriptor ready status is indicated, the command manager 720 fetches the command descriptor and increments the transmit queue consumer index 712. Using the tag field in the command descriptor, the command manager 720 fetches the appropriate tag context from the tag area. In addition, the command manager fetches additional data from the location pointed to by the IU pointer based on the length field in the command descriptor. See block 810.

As represented by block 812, the command manager 720 assembles the frame to be sent to the storage device. Here, the command manager reads the protocol field in the tag context to determine the appropriate protocol format for the frame. In addition, the command manager adds a reference to the tag to the frame (e.g., in the header area of the frame).

As represented by block 814, the connection manager 722 checks the connection tag from the tag context for connection status. The connection manager 722 opens the connection in initiator or target mode based on the initiator field in the tag context. For example, if the connection tag does not match an open connection, the connection manager 722 may use the source and destination addresses to open a connection. The connection manager 722 also generates a connection opened message for the command manager 720.

As represented by block 816, the command manager 720 loads the frame into the transmit transport buffer (e.g., by loading the frame into the transmit FIFO 732) of the transmit protocol stack 740 based on the connection opened message.

The transmit protocol stack performs the appropriate protocol processing to send out the frame (block 818). For example, SAS frames are processed by a SAS protocol stack (e.g., stack 440 in FIG. 4) and SATA frames are processed by a SATA protocol stack (e.g., stack 438).

Finally, as represented by block 820, the frame is transmitted to the data storage device via a port in the controller (e.g., port 0 in FIG. 4).

Referring now to FIG. 9, after the storage device processes the command frame it will send a response frame back to the controller (block 902). The response frame will include a reference to the tag from the command frame. A frame is received via a port (e.g., port 0 in FIG. 4) using the receive protocol stack 744 and loaded into the receive transport buffer of the protocol stack 744. The frame may then be retrieved from the receive FIFO 742.

As represented by block 904, processing of the frame depends on the frame type. For example, if the frame is a transfer ready frame it is processed by the transfer ready manager 748. If the frame is a data frame it is processed by the receive DMA engine 730. A frame manager 750 processes other frame types.

The storage device sends a transfer ready frame to the controller in response to a write command. The transfer ready frame indicates that the storage device is ready to accept the write data. Accordingly, the transfer ready manager 748 initiates the necessary operations in the transmit path to cause the write data to be sent to the storage device. This is accomplished through the transfer ready queue 736.

As represented by block 906, the transfer ready manager 748 accesses the tag and other information from the received frame. This information may include, for example, the tag, the target tag (if applicable), a data offset, and the length fields of the transfer ready frame. The transfer ready manager 748 then loads this information into the transfer ready queue 736 (block 908). The write operations that follow are discussed below in conjunction with FIG. 11.

Referring to block 916, the storage device sends a data frame to the controller in response to a read command. The receive DMA engine 730 accesses the tag context using the tag information in the received frame. In initiator mode the receive DMA engine 730 uses the initiator tag. In target mode the receive DMA engine 730 uses the target tag. Based on the selected information, the receive DMA engine 730 processes the data frames and loads the data into the appropriate area of the SGL.

As represented by block 920, the receive DMA engine 730 may also load a dummy completion frame into the receive frame area 708 based on the DMA completion.

Referring to block 910, the frame manager 750 handles other types of frames such as unsolicited frames, responses and target mode commands. The frame manager 750 may access tag and other information to process these frames. The frame manager 750 loads these frames into the receive frame area 708 (block 912) and increments the receive queue producer index 714 (block 914).

Here, the receive queue producer index 714 and the receive queue consumer index 716 are used to indicate that the hardware has loaded a frame into the receive frame area 708. When the producer index 714 “exceeds” the consumer index 716, the software will fetch the frame from the receive frame area 708 and increment the receive queue consumer index 716. The software then processes the frame, as necessary.

An arbiter 760 may implement an arbitration scheme to control access to, for example, the PCIX bus by the receive DMA engine 730 and the frame manager 750.

Referring now to FIG. 10, an example of an initiator read operation will be discussed. As represented by -block 1002 the read command is enqueued as discussed above in conjunction with FIG. 8. The storage device then processes the read command and sends a data frame back to the controller (block 1004) using the receive protocol stack 774. The data frame is then loaded into the receive FIFO 742.

As represented by block 1006, the receive DMA engine 730 uses the initiator tag as the reference to the proper tag context. The receive DMA engine 730 then processes the received data and loads the data into the SGL location identified by the tag context (block 1008).

After sending the data frame(s) associated with the read command, the storage device sends a response frame indicating that the storage device has completed processing the read command. As represented by block 1010-1014, the frame manager 750 accesses the appropriate tag context, processes this received response frame according to that context, loads a response frame into the receive frame area and increments the producer index 714.

As represented by block 1016, the software retrieves the response frame and increments the consumer index 716. The software then retires the tag in response to the command completion response frame.

Referring now to FIG. 11, an example of an initiator write operation will be discussed. As represented by block 1102 the write command is enqueued as discussed above in conjunction with FIG. 8. In response to the write command the storage device sends a transfer ready frame to the controller (block 1104) via the receive protocol stack 774. The transfer ready frame is then loaded into the receive FIFO 742.

As represented by block 1106, the transfer ready manager 748 uses the initiator tag to access the proper tag context. The transfer ready manager 748 processes the frame to load the frame and the tag context into the transfer ready queue 736.

A pending transfer ready frame in the queue 736 triggers the transmit DMA engine 728 to fetch the write data from memory according to the information provided by the tag context. The transmit DMA engine 728 may then load the write-data into the transmit FIFO 732 (block 1108). Using the appropriate protocol processing, the write data is sent to the data storage device.

After the storage device stores the write data it sends a command complete response frame back to the controller (block 1110). As discussed above, response frames are handled by the frame manager 750. Accordingly, the frame manager 750 accesses the appropriate context, and processes the response frame to load it into the receive frame area 708 (blocks 1112-1114).

As represented by block 1116, the software retrieves the command completion response frame and retires the tag.

Referring now to FIG. 12, a data storage system 1200 includes a controller 1202 that may operate as a target and as an initiator. A host 1204 connected to the controller 1202 (e.g., via a PCI bus) may send read and write commands to the controller to access data in a storage device 1206. In this operation, the controller 1202 is the initiator and the storage device 1206 is the target. In the embodiment of FIG. 12, the controller 1202 connects to the storage device 1206 via an expander 1208.

The controller 1202 also processes requests from devices connected to the controller's ports. For example a device 1210 such as another controller or a storage device may send a read or write command to the controller 1202 to access the storage device 1206. As to the command from the device 1210 to the controller 1202, the device 1210 is the initiator and the controller 1202 is the target.

However, the controller also must perform operations to access the storage device 1206. For example, the controller 1202 may send a read or write command to the storage device 1206. As to this command, the controller 1202 is the initiator and the storage device 1206 is the target. Hence, to process the command from the device 1210, the controller 1202 performs both target and initiator operations.

Referring now to FIG. 13, an example of a target read operation where an initiator (e.g., device 1210 in FIG. 12) sends a read command frame to the controller will be discussed. As represented by block 1302 a read command frame received via a port (e.g., port 0 in FIG. 4) and the receive protocol stack 744 (FIG. 7) is temporarily stored in the receive FIFO 742.

As discussed above in conjunction with FIG. 9, the frame manager 750 handles command frames received by the receive data path. As represented by block 1304, the frame manager 750 processes the received frame to load it into the receive frame area 708.

As represented by block 1306, software processes the received frame and determines that it must read data from a storage device. Accordingly, the software initiates an initiator read as discussed above in conjunction with FIG. 10. At this point, the read data is stored in a memory such as host memory that is readily accessible to the controller.

After receiving the command complete response frame from the storage device, the software generates a frame for the transmit data path. In this case the command descriptor includes a reference to a unique tag for the target tag field (block 1308).

As represented by block 1310 the frame's target tag is captured by the target read manager 724 into the target read queue 738. An entry in the target read queue 738 triggers the transmit DMA engine 728 to fetch the read data from memory and generate data frames toward the transmit transport buffer of the transmit protocol stack 740 (block 1312).

After the data frame is sent to the original initiator (e.g., device 1210), the frame manager 750 loads a dummy completion frame into the receive frame area 708 (block 1314). As represented by block 1316, upon receiving the dummy completion frame the software uses the information in the dummy frame to send a command complete response frame to the original initiator. This target mode response frame is sent via the transmit data path in a similar manner as discussed above. The software then retires the associated tag.

Referring now to FIG. 14, an example of a target write operation where an initiator (e.g., device 1210 in FIG. 12) sends a write command frame to the controller will be discussed. As represented by block 1402 the write command frame received via a port (e.g., port 0 in FIG. 4) and the receive protocol stack 744 (FIG. 7) is temporarily stored in the receive FIFO 742.

As discussed above in conjunction with FIG. 9, the frame manager 750 handles command frames received on the receive data path. As represented by block 1404, the frame manager 750 processes the received frame to load it into the receive frame area 708.

As represented by block 1406, software processes the received frame and, when there is bandwidth available in the controller, sends a transfer ready frame to the original initiator (e.g., device 1210). Thus, the software generates a frame for the transmit data path where the associated command descriptor includes a reference to a unique tag for the target tag field.

After receiving the transfer ready frame, the original initiator sends the write data to the controller (block 1408). The receive DMA engine 730 loads the received write data into the SGL. Here, the location in the SGL is specified by the tag context for the target tag. The reference to the target tag was initially provided in the transfer ready frame and is provided to the receive DMA engine 730 by the write data frame (block 1410). Thus, at this point the write data is stored in a memory such as host memory that is readily accessible to the controller.

Next, the software initiates an initiator write as discussed above in conjunction with FIG. 11 to transfer the write data to the storage device (block 1412). After completion of the data transfer (e.g. receipt of the command complete response frame from the storage device), the hardware loads a dummy completion frame into the receive frame area 708 (block 1414).

As represented by block 1616, upon receiving the dummy completion frame the software uses the information in the dummy frame to send a command complete response frame to the original initiator. This target mode response frame is sent via the transmit data path in a similar manner as discussed above. The software then retires the associated tag.

The use of tags as described herein provides an efficient mechanism to handle data transfers when the controller is both an initiator and a target. For example, more than one port may efficiently be used to handle the data transfers since data does need to be “moved” from one port to another or coordinated between ports using, for example, cross stack communication. Rather, since each of the respective port controllers may access any of the tag contexts, the port controllers have access to all the information needed to facilitate data transfer through each port.

Although the above discussion may refer generally to a data storage device, it should be appreciated that the controller may be configured to appear to an initiator (e.g., the host) as accessing a single storage device although it may in fact be accessing several storage devices. For example, where an initiator (e.g., a host or other device) requires a high throughput link to data storage, the controller can “present” a virtual device to the host. In this case, the controller may actually be an initiator to several target storage devices (the physical devices that constitute the virtual device) that collectively provide the required throughput.

In some embodiments, when a data transfer is from initiator to target, a DMA Activate FIS is sent to the initiator. After reception of the DMA Activate FIS the initiator will transfer the data through Data FIS in packets and every packet is preceded by a DMA Activate FIS from the target. Based on the “TBL” bit of Target Command field, the target uses either the DMA_LENGTH field or the length field from the fetched PRD entry from the table to determine the end of transfer. At the end of the transfer the target sends a register FIS to indicate a successful completion of the data transfer. An interrupt may be generated to the target to signal command completion.

In some embodiments, when a data transfer is from target to initiator, the target will transfer data through Data FIS in packets. Based on the “TBL” bit of Target Command field, the target uses either the DMA_LENGTH field or the length field from the fetched PRD entry from the table to determine the end of transfer. At the end of the transfer the target sends a register FIS to indicate a successful completion of the data transfer. An interrupt may be generated to the target to signal command completion.

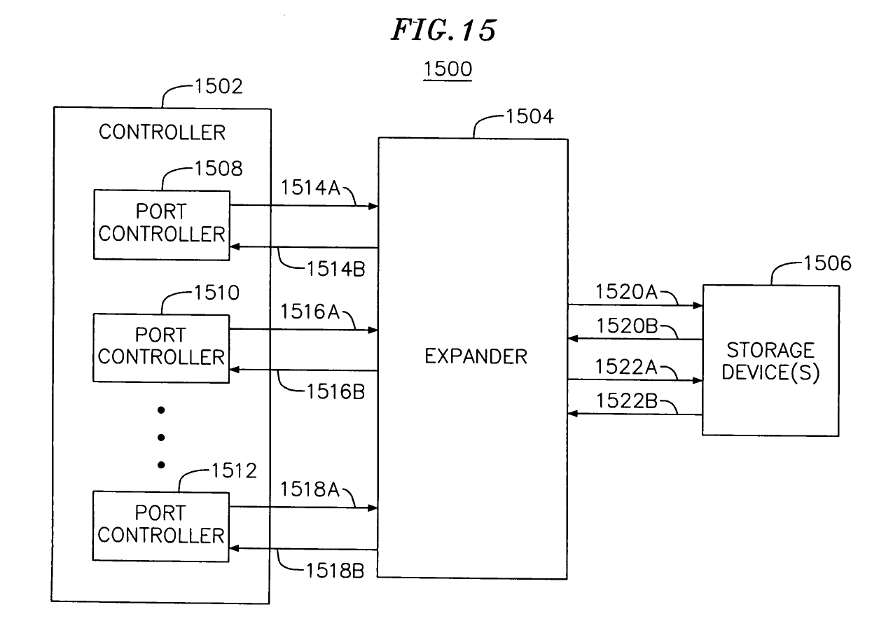

Referring now to FIG. 15, one embodiment of parallel port processing using the techniques described herein will be discussed. In a data storage system 1500, a controller 1502, an expander 1504 and one or more storage devices 1506 are illustrated. The controller 1502 includes several port controllers (e.g., port controllers 1508, 1510 and 1512). The port controllers 1508, 1510 and 1512 may connect to the expander via ports 1514A-B, 1516A-B and 1518A-B, respectively, thereby providing a wide-port connection to the expander. The expander 1504 may connect to the storage device(s) 1506 via ports 1520A-B and 1522 A-B.

The use of tags as described herein provides an efficient mechanism to handle data transfers for wide-ports. For example, more than one port may be used to handle the data transfers into or out of the controller 1502. In particular, the software may monitor the status of the transfer ready frames to determine which ports are currently available to handle data transfers. Thus, the software may select any of the ports connected to the expander as necessary to improve throughput.

This process also may be more efficient than conventional schemes because data does need to be “moved” from one port to another or coordinated between ports using, for example, cross stack communication. Rather, the respective port controllers 1508, 1510 and 1512 may use the tags to access the information needed to facilitate data transfer into or out of each port. Thus, data may be transferred between the controller 1502 and the storage device(s) 1506 using any of the ports 1514A-B, 1516A-B and 1518A-B or any of the ports 1520A-B and 1522 A-B.

Moreover, through the use of tags the software may efficiently determine how the wide-port data transfers are divided up among the ports. As a result, the hardware does not need to keep track of where the data transfers have been routed. As a result, a system constructed according to the invention may be easier to scale than conventional systems.

The use of tags also provides an advantage wherein in the event all hardware acceleration resources are busy processing data transactions, the software may handle some of the data processing until hardware resources are freed up. For example, when the acceleration hardware cannot handle an incoming packet, the hardware places the frame and dummy frames in the receive frame area and sets appropriate flags. The dummy frames contain information that the software processes in conjunction with the operation. As discussed herein, information the software needs to process the frame may be obtained from the corresponding tag.

Software may then monitor information associated with the hardware (e.g., the number of read or write transactions in process) to determine whether the packet processing may be sent back to the hardware. As discussed above, a command to process a packet may be triggered by loading the appropriate information into the command descriptor.

From the above, it should be appreciated that when a hardware path is busy, the software may move a transfer designated for that hardware path to the software path. The software may also reassign the transfer to any idle hardware path that provides the desired connection.

When a transaction is completed successfully, a response needs to be sent back to the initiator indicative of this. In some embodiments, the software places the appropriate response at the end of the scatter gather list (“SGL”). The hardware then processes the data associated with the SGL. If there are no errors the hardware may automatically send the response at the end of the scatter list to the initiator. If there are errors, the hardware may send, for example, an error message (e.g., generated by software) to the initiator instead of the response at the end of the scatter list. Hence, this method may provide responses in the majority of transactions (all “no error” transactions) with relatively little or no latency/stall.

A controller constructed according to the teachings herein also may provide efficient full rate data transfers for bi-directional transactions. Such transactions may be processed relatively efficiently in a system constructed according to the teachings herein because the transmit and receive operations are performed by separate hardware paths (as depicted, for example, in FIGS. 4 and 7) In bi-directional transactions the controller may keep track of two separate sets of SGLs that are associated with the same tag. That is, both transmit and receive operations may use the same tag. In this case, since the completion of the bi-directional transaction involves the completion of both sides of the transaction, the software may send the “transaction complete” response to the initiator instead of using the hardware scheme using the SGL described above.

The use of tags as described herein also facilitates sending large packets of data. For example, if the hardware uses 128KB buffers and a 1MB data packet is to be sent, the hardware may pass the packet back to the software and the software can then use information in the tag (or stored in some other location in a data memory) to determine whether the entire data packet has been sent. If not, the software may continue to resend the packet to hardware (using the techniques discussed above) until the entire packet is sent.

The controller may efficiently aggregate ports through the use of tags. For example, several ports may be ganged together to present a single virtual port. Here, the context of the corresponding data transfers may be tracked via the tags.

From the above, it should be appreciated that a system or apparatus incorporating the teachings herein may incorporate a variety of features. In one embodiment, per-port QDMA engines include 256 independent queue entries per SAS/SATA port, the QDMA fetch engine retrieves descriptors without CPU intervention and the QDMA engines provide per-port interrupt coalescing. As discussed above every port may be configured for target and/or initiator operation. Drive side command queuing may be provided with sequential non-zero buffer offset support. Separate protocol stacks may be provided to all ports. A merged host interface may be provided for the SAS and SATA stacks (per port). Tags may be unique per chip. Software may choose, on a per command basis, whether to handle an operation manually (e.g., in software rather than hardware). Software may be responsible for target-mode completions (responses) on bi-directional and write commands, but may use full hardware acceleration for target reads.

The transmit queue may be associated with features such as: unified queue for issuing commands, sending primitives and sending target frames; no synchronization required for order of issuance; configurable depth, e.g., up to 64K entries per port; little or no waiting for relatively large systems; software may have total freedom in how to allocate tags as long as they are held unique during their life span; entries may have very limited life span, thus the transmit queue may be very small; issuing commands gets priority, thus the faster a command gets into the target queue, the more drive-side optimization; command and frame data has full scatter-gather support, e.g., identical to receive buffers.

The transaction engine may be associated with features such as: fully bidirectional XAE (transaction acceleration engines); bi-directional commands occur at full hardware speeds, whether in target or initiator mode; maximum utilization of data paths; simultaneous target and initiator mode; integrated tag pool for SSP/SMP/STP and SATA transactions, each port operating in SATA mode may reserve a predefined number of tag entries; software does not need to split commands since it can take action when a scatter-gather list is exhausted, e.g., in target mode, the controller receives a 1MB request, but has only 128KB of buffer space free. It can begin processing the command with the first 128K, then enqueue the additional segments as memory or data becomes available.

The receive queue may be associated with features such as: depth configurable separate from command queue, e.g., up to 64K entries per port; receive buffers are mapped through scatter-gather lists; minimal demand for contiguous memory; fully integrated with credit management and status update block; all transmit and receive operations may be zero-read.

SGL preparation routines may be used to process: outgoing commands and data packets; data to be shipped through the tag processing engine (TPE); responses as they are received on the wire.

Command issuance routines may be used to provide: tag generation synchronization; quick sort for SMP/SSP and per-connection; issuance of primitives; initial packet send for target responses.

Response handler routines may be used to provide: receive all packets without tag information or cached transfer information, and SMP frames; same scatter-gather format as commands and data area; interrupt generation is per-tag or unsolicited frame received.

Different embodiments of the invention may include a variety of hardware and software processing components. In some embodiments of the invention, hardware components such as controllers, state machines and/or logic are used in a system constructed in accordance with the invention. In some embodiment of the invention, code such as software or firmware executing on one or more processing devices may be used to implement one or more of the described operations.

Such components may be implemented on one or more integrated circuits. For example, in some embodiments several of these components may be combined within a single integrated circuit. In some embodiments some of the components may be implemented as a single integrated circuit. In some embodiments some components may be implemented as several integrated circuits. For example, in some embodiments the SAS/SATA block 422 depicted in FIG. 4 may be implemented as a single chip. In other embodiments all of the components depicted in FIG. 4 may be implemented on a single chip.

The components and functions described herein may be connected/coupled in many different ways. The manner in which this is done may depend, in part, on whether the components are separated from the other components. In some embodiments some of the connections represented by the lead lines in the drawings may be in an integrated circuit, on a circuit board and/or over a backplane to other circuit boards. In some embodiments some of the connections represented by the lead lines in the drawings may comprise a data network, for example, a local network and/or a wide area network (e.g., the Internet).

The signals discussed herein may take several forms. For example, in some embodiments a signal may be an electrical signal transmitted over a wire while other signals may consist of light pulses transmitted over an optical fiber. A signal may comprise more than one signal. For example, a differential signal comprises two complementary signals or some other combination of signals. In addition, a group of signals may be collectively referred to herein as a signal.

Signals as discussed herein also may take the form of data. For example, in some embodiments an application program may send a signal to another application program. Such a signal may be stored in a data memory.

The components and functions described herein may be connected/coupled directly or indirectly. Thus, in some embodiments there may or may not be intervening devices (e.g., buffers) between connected/coupled components.

In summary, the invention described herein generally relates to an improved data storage controller. While certain exemplary embodiments have been described above in detail and shown in the accompanying drawings, it is to be understood that such embodiments are merely illustrative of and not restrictive of the broad invention. In particular, it should be recognized that the teachings-of the invention apply to a wide variety of systems and processes. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the scope and spirit of the invention as defined by the appended claims.

1. A data transfer method comprising:
associating unique tags with data transfer operations;
associating context information with each tag; and
using the context information to transfer data associated with the data transfer operations through a plurality of ports.

2. The method of claim 1 wherein the data is transferred without cross stack communication.

3. The method of claim 1 comprising associating a command descriptor with each data transfer operation, wherein the command descriptor identifies the unique tag associated with each data transfer operation.

4. The method of claim 1 wherein the data is DMAed between memory and a data storage controller.

5. The method of claim 1 wherein hardware in a data storage controller automatically DMAs the data between memory and the data storage controller.

6. The method of claim 1 wherein hardware in a data storage controller uses the context information to automatically DMA the data between memory and the data storage controller.

7. The method of claim 1 wherein data transfer operations may be selectively handled by software or hardware.

8. The method of claim 1 wherein any of the ports may process data transfer operations associated with any of the tags.

9. The method of claim 1 wherein command responses are sent automatically by hardware.

10. The method of claim 1 wherein status information is automatically uploaded to memory without a read operation.

11. A wide-port data transfer method comprising:
associating unique tags with wide-port data transfer operations;
associating context information with each tag; and
using the context information to transfer data associated with the wide-port data transfer operations through a plurality of ports without cross stack communication.

12. The method of claim 11 comprising associating a command descriptor with each data transfer operation, wherein the command descriptor identifies the unique tag associated with each data transfer operation.

13. The method of claim 11 wherein hardware in a data storage controller automatically DMAs the data between memory and the data storage controller.

14. The method of claim 11 wherein hardware in a data storage controller uses the context information to automatically DMA the data between memory and the data storage controller.

15. The method of claim 11 wherein the data transfer operations may be selectively handled by software or hardware.

16. The method of claim 11 wherein any of the ports may process data transfer operations associated with any of the tags.

17. The method of claim 11 wherein command responses are sent automatically by hardware.

18. The method of claim 11 wherein status information is automatically uploaded to memory without a read operation.

19. A data transfer method comprising:
providing separate hardware transmit and receive paths for data transfer operations though a port;
associating a unique tag with each concurrent data transfer operation;
associating context information with each tag; and
using the context information to transfer data associated with one of the data transfer operations through the separate hardware transmit and receive paths.

20. The method of claim 19 wherein the data is transferred without cross stack communication.

21. The method of claim 19 comprising associating a command descriptor with each data transfer operation, wherein the command descriptor identifies the unique tag associated with each data transfer operation.

22. The method of claim 19 wherein the transmit and receive paths comprise DMA engines to automatically transfer data between memory and a data storage controller.

23. The method of claim 19 wherein the transmit and receive paths comprise DMA engines and use the context information to automatically transfer data between memory and a data storage controller.

24. The method of claim 19 wherein command responses are sent automatically by hardware.

25. A data storage-controller comprising:
a plurality of ports comprising:
a transmit path comprising at least one DMA engine; and
a receive path comprising at least one DMA engine; and
at least one data memory for storing unique tags associated with data transfer operations and context information associated with each tag;
wherein the transmit path and the receive path use the context information to transfer data associated with the data transfer operations through a plurality of ports.

26. The data storage controller of claim 25 wherein the data is transferred without cross stack communication.

27. The data storage controller of claim 25 wherein a command descriptor associated with each data transfer operation identifies the unique tag associated with each data transfer operation.

28. The data storage controller of claim 25 wherein the DMA engines use the tag context to DMA data between and external memory and a data storage controller.

29. The data storage controller of claim 25 comprising at least one queue for storing transfer ready frames received on the receive data path.

30. The data storage controller of claim 25 comprising at least one queue for storing target read frames from the transmit data path.
